(19) United States
(12) Patent Application Publication
(10) Pub. No.: US 2016/0052693 A1
(43) Pub. Date: Feb. 25, 2016

(54) METHOD OF MAKING PACKAGED FOOD PRODUCT

(71) Applicant: Jeanne CHENG, Santa Monica, CA (US)

(72) Inventor: Jeanne CHENG, Santa Monica, CA (US)

(21) Appl. No.: 14/931,257

(22) Filed: Nov. 3, 2015

Related U.S. Application Data
(62) Division of application No. 13/921,372, filed on Jun. 19, 2013.
Application No. 13/921,372 is a continuation-in-part of application No. 13/870,712, filed on Apr. 25, 2013, now abandoned.

(51) Int. Cl. B65D 81/24; B65B 51/10; B65D 65/38; B65B 25/14; A23L 1/00; A23L 1/337

(52) U.S. Cl. CPC B65D 81/245; A23L 1/0067; A23L 1/337; B65D 65/38; B65B 25/146; B65B 51/10; A23V 2002/00

(57) ABSTRACT

A packaged food product and a method for assembling a packaged food product that includes an edible sheet-like layer enclosing edible contents as a roll, the edible sheet-like layer and the edible contents separated from each other by a removable vapor barrier for maintaining freshness of the edible sheet-like layer until the food product is ready to be consumed, the removable vapor barrier being graspable by the user for removing it from the rest of the assembled product.

### FIELD OF THE INVENTION

The present invention relates to packaged food product and a method for assembling a packaged food product that includes an edible sheet-like layer enclosing edible contents as a roll, the edible sheet-like layer and the edible contents separated from each other by a removable vapor barrier for maintaining the freshness of the sheet material until the food product is ready to be consumed, the removable vapor barrier extending past the end of the roll to be graspable by the consumer for removing same.

### BACKGROUND OF THE INVENTION

Seaweed is becoming a popular snack food item in America, particularly as an edible wrap around other edible ingredients. Seaweed offers a healthful alternative to tortillas and other wrappable products, particularly among those intolerant to wheat products.

A downside to using seaweed, however, is that it loses its crispiness and texture easily when exposed to moisture. When wrapped about an arrangement of food ingredients in a form such as a roll, the moisture of the other edible ingredients degrade the quality of the edible wrap, thus reducing the shelf-life of the product. Other edible sheet-like foods that may perform a similar function for wrapping and containing other edible ingredients are also susceptible to this phenomenon, discouraging their use in the form of a roll, which might be otherwise convenient and desirable to the consumer.

### SUMMARY OF THE INVENTION

The object of the invention a packaged food product including edible filler ingredients within an edible sheet-like wrap (e.g., seaweed), where the crispiness and the freshness of the wrap is maintained, thereby providing an enjoyable portable food product that can be easily and quickly prepared and also offers a reasonable shelf-life.

In order to accomplish this object, an exemplary embodiment of the invention comprises a packaged food product that includes a non-edible first layer of sheet-like material, a second layer of edible sheet-like material on a surface of the first layer, a non-edible third layer of sheet-like material on a surface of the second layer facing opposite the surface of the first layer, an edible fourth layer of an edible substrate on a surface of the third layer facing opposite the surface of the second layer that extends from a first edge of the third layer toward an opposite second edge of the third layer wherein an extended region of this third layer at the second edge is free of the edible substrate of the fourth layer, and a fifth layer of edible ingredients on the fourth layer, the edible ingredients provided on a side of the fourth layer facing opposite the surface of the third layer, wherein the first, second, third, fourth, and fifth layers form an assembly that is rolled about itself, the fifth layer forming a center of the assembly, the first layer forming an outermost layer, and the extended region of the third layer extending out from one end of the assembly, wherein the third layer provides a removable vapor barrier between the fourth layer of the edible substrate and the edible sheet-like second layer, wherein the third layer is slideable from between the second and fourth layers such that the third layer may be pulled, by grasping the extended region, so as to be removable from the assembly by pulling the extended region away from a remainder of the assembly.

In a particular embodiment of the invention, the second layer may be seaweed or nori.

In a particular embodiment of the invention, the non-edible first layer and the non-edible third layer each consist of transparent plastic food wrapping material. The transparent plastic food wrapping material, for example, may be cellophane.

In a particular embodiment of the invention, the edible substrate of the fourth layer is or includes a layer of rice.

In a particular embodiment of the invention, the edible substrate of the fourth layer is or includes a layer of grain and bean mixture.

In a particular embodiment of the invention, the edible substrate of the fourth layer is or includes a layer of egg.

In a particular embodiment of the invention, the edible second layer is or includes a leafy green vegetable.

In a particular embodiment of the invention, the edible second layer is or includes a soy sheet.

In a particular embodiment of the invention, both ends of the rolled assembly are sealed from the outside by the non-edible first layer.

In a particular embodiment of the invention, a holding element is provided at the bottom end of the rolled assembly where the extended region of the third layer is located. This holding element has a hole extending through its thickness, and at least a portion of the extended region is passed through from a first side of the holding element to an opposite second side via this hole, the first side facing (or also resting against) the edible parts of the assembly. When the extended region is grasped and pulled, the hole permits the third layer to slide through under the influence of a pulling action while the holding element prevents passage of the edible second, fourth, and fifth layers.

In a particular embodiment of the invention, the holding element is flat, and/or is formed as a disc or disc-like object.

In a particular embodiment of the invention, the first layer has an extending region that extends by a length sufficient to wrap around and/or surround at least a portion of the holding element. This extending region of the first layer may also extend sufficiently to surround at least a portion of the extended region of the third layer extending through the hole of the holding element.

In a particular embodiment of the invention, a fastener, such as a clip or a tie (e.g., twist-tie), is fitted around the extended region of the third layer that extends through the hole of the holding element to close and/or seal this end of the third layer. The fastener may also be fitted around the extending region of the first layer thereby to close and/or seal this layer, too.

In a particular embodiment, the holding element described above forms the bottom of a cup or cup-like element fitted over the assembly at the end where the extended region of the third layer is located. The walls of the cup or cup-like element extend partially up along the length of the assembly, and the extended region of the third layer extends through the hole in the holding portion that forms the bottom of the cup. The hole of the cup or cup-element is configured to permit the third layer to slide through the hole when pulled, whereas the edible second, fourth, and fifth layers are prevented from passing therethrough. The walls of the cup or cup-like element serve as a handle for gripping and holding the cup or cup-like element as the extended element is pulled. In this embodiment, a fastener such as a clip or a tie may be provided around the extended region of the third layer that extends through the hole to close and/or seal the third layer.

The object of the invention may also be accomplished by a method for assembling the packaged food product described above, including the steps of providing a first non-edible layer of sheet-like material on a preparation surface, the first non-edible layer having a first edge, a second edge opposite said first edge, and two opposite side edges, spreading a thin layer of an edible substrate onto the first flexible non-edible material between the first edge of the first non-edible layer and the second edge of the first non-edible layer, an extended region of the first non-edible layer at the second edge remaining free of the edible substrate, placing a layer of one or more edible ingredients on the edible substrate along a center line of the edible substrate, lifting the two opposite side edges of the first non-edible layer from the preparation surface, and bringing the two opposite side edges together to enclose the edible substrate around the layer of one or more edible ingredients, placing a first of the two opposite side edges over a second of the two opposite side edges to close the first non-edible layer around the edible substrate and the layer of one or more edible ingredients, such that the first non-edible layer, the edible substrate, and the layer of one or more edible ingredients form a rolled sub-assembly, rolling the rolled sub-assembly inside an edible sheet-like food substance to form a second rolled sub-assembly, rolling the second rolled sub-assembly into a second non-edible layer of sheet-like material to form a rolled final assembly, and securing the second non-edible layer to prevent the second non-edible layer from unrolling, wherein the first non-edible layer is a vapor barrier that prevents transmission of moisture from the edible substrate to the sheet-like food substance, wherein the first non-edible layer is slideable from between the sheet-like food substance and the edible substrate such that the first non-edible layer may be pulled, by grasping the extended region, and removed from between the sheet-like food substance and the edible substrate.

In a particular embodiment of the method described above, the step of rolling the second rolled sub-assembly into a second non-edible layer of sheet-like material includes the sub-steps of partly rolling the second rolled sub-assembly into a first portion of the second non-edible layer of sheet-like material, folding up a bottom end of the partly rolled second non-edible layer against an exposed surface of the second non-edible layer, securing an end-most portion of the folded bottom end to the exposed surface of the second non-edible layer, and rolling the second rolled sub-assembly around a remainder portion of the second non-edible layer.

In a particular embodiment of the method described above, oil (i.e., food or cooking oil) is mixed into the edible substrate to facilitate sliding between the first non-edible layer and the edible substrate.

In another particular but non-limiting embodiment of the method, the first non-edible layer is treated with non-stick spray on a side that contacts the edible substrate to facilitate sliding between the first non-edible layer and the edible substrate.

In another particular but non-limiting embodiment of the method, the second non-edible layer is sealed at an open end of the rolled final assembly to prevent exposure of the edible substrate, edible ingredients, and edible sheet-like material to the outside.

In another particular but non-limiting embodiment of the method, a heat sealable food wrapping material is provided as the second non-edible layer, and the second non-edible layer is sealed by heat-sealing.

In another particular but non-limiting embodiment of the method, after the step of placing the first of the two opposite side edges over the second of the two opposite side edges to close the first non-edible layer and form the rolled sub-assembly, a holding element, having a hole extending therethrough, is provided at an end of the rolled sub-assembly such that a first surface of the holding element faces (and may also rest against) the end of the rolled sub-assembly. The extended region of the first non-edible layer is placed through the hole of the holding element so that the extended region extends out from an opposite second surface of the holding element. The extended region may be twisted about itself to fit more easily through the hole of the holding element. Additionally, the extended region, extending from the hole, may be fitted with a fastener such as a clip or a tie to close and/or seal the third layer. The first non-edible layer at the end of the first rolled sub-assembly opposite the extended region remains open, so that the first non-edible layer may slide along an outer surface of the edible fourth layer.

In another particular but non-limiting embodiment of the method, after the step of rolling the second rolled sub-assembly around the remainder portion of the second non-edible layer to form the rolled final assembly, a cup or cup-like element, having a hole extending through a bottom thereof, is provided at an end of the rolled final assembly such that an inner surface of the bottom of the cup or cup-like element faces (and may also rest against) the end of the rolled final assembly. The extended region of the first non-edible layer is placed through the hole at the bottom of the cup or cup-like element so that the extended region extends out from an outer surface of bottom of the cup or cup-like element.

The inventive packaged food product and the steps outlined above provides a convenient snack or meal that can be quickly assembled from prepared food items, such as at a salad station, and held in one hand by the consumer as it is eaten. Unlike other handheld packaged food items in the art, the invention features an edible sheet-like ingredient, such as seaweed, that otherwise loses its attractiveness and taste as it absorbs moisture from its surroundings. By providing a vapor barrier between the inner ingredients and the edible sheet-like ingredient, the sheet-like ingredient retains its freshness. The invention provides such a vapor barrier in a form that is easily and conveniently removable when the consumer is ready to consume the product without causing the other ingredients to come apart or spill out from the assembly. Thus, the invention provides a workable packaged food product wherein all the ingredients, including the delicate sheet-like ingredient stay fresh longer.

### BRIEF DESCRIPTION OF THE DRAWINGS

FIG. 1 shows a top-down view of edible ingredients of the invention placed on a first non-edible layer of sheet-like material.

FIG. 2 shows a following step, wherein opposite edges of the first non-edible layer are grasped and brought together.

FIG. 3 shows a following step with the first non-edible layer rolled about itself with the edible ingredients contained within.

FIG. 4 shows a following step where a sheet of seaweed is rolled around the outside of the roll of FIG. 3.

FIG. 5 shows the roll of FIG. 4 partially wrapped inside a second non-edible layer with a bottom of the second non-edible layer folded and secured to itself.

FIG. 6 shows the roll of FIG. 5 in a completed state, with the second non-edible layer fully wrapped around itself with the roll of FIG. 4 contained within, except for a remainder portion of the first non-edible layer extending out one side of the wrapped second non-edible layer.

FIG. 7 illustrates a step of grasping the exposed remainder portion of the first non-edible layer for pulling same from out from the roll of FIG. 6.

FIG. 8 illustrates the roll of FIG. 7 in a ready-to-eat state, the first non-edible layer removed and the second non-edible layer peeled downward to expose the edible components within.

FIG. 9 illustrates a second embodiment of the invention, wherein an end of the exposed remainder portion of the first non-edible layer is twisted about itself and placed through the hole of a flat element.

FIG. 10 illustrates the roll of FIG. 9 partially wrapped inside a second non-edible layer.

FIG. 11 illustrates the roll of FIG. 10 in a completed state, with the second non-edible layer fully wrapped around itself with the roll of FIG. 9 contained within, except for a remainder portion of both the first and second non-edible layers extending out one side and secured with a clip.

FIG. 12 illustrates a step of removing the clip from the roll of FIG. 11.

FIG. 13 illustrates a step of grasping the exposed remainder portion of the first non-edible layer for pulling same from out from the roll of FIG. 12.

FIG. 14 illustrates the roll of FIG. 13 in a ready-to-eat state, the first non-edible layer removed and the second non-edible layer peeled downward to expose the edible components within.

FIG. 15 illustrates a non-limiting variation of the step shown in FIG. 13, wherein the flat element is substituted with a cup-like element, and the exposed remainder portion of the first non-edible layer is grasped and pulled out through a holed in the cup-like element.

### DETAILED DESCRIPTION OF THE PREFERRED EMBODIMENTS

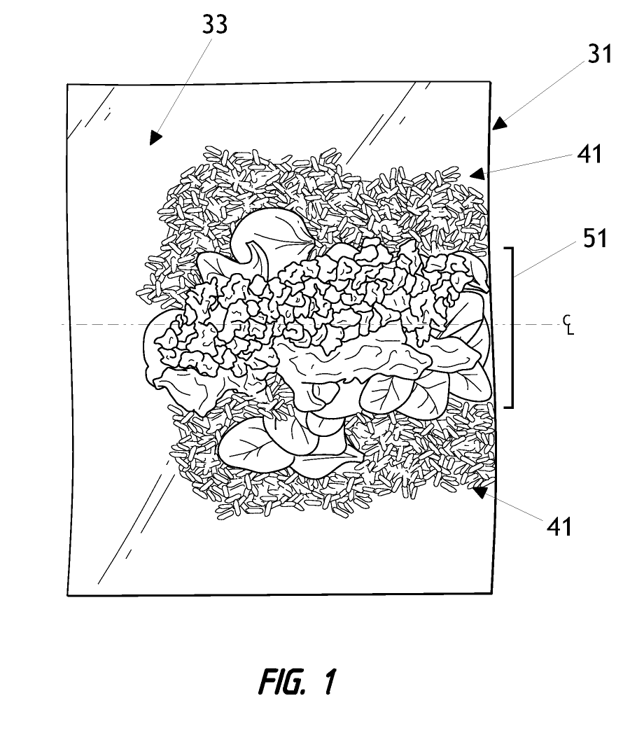

According to a non-limiting, exemplary embodiment of the inventive packaged food product an internal arrangement of edible ingredients 51 is arranged as shown in FIG. 1. As shown in the Figure, an edible mixture 51 is laid atop an edible layer 41, which in turn is laid atop a first non-edible sheet-like material 31.

The edible mixture 51 may comprise a wide variety of ingredients, such as chopped ground meat, chopped vegetables, meat, fish, egg, tofu, bean, avocado, grain ingredients, etc. The edible layer 41 as shown is rice; however, the edible layer may also be formed of egg (i.e., scrambled egg mixture), a mix of edible grains capable of sticking to itself, or other edible foods (meat, vegetables, fish) in a form capable of forming a cohesive layer that can be shaped around the edible ingredients 51 under the influence of the first non-edible material 31.

The edible layer 41 and the edible mixture 51 are arranged generally along a center line (C/L) extending horizontally across the first non-edible material 31. The edible layer 41, and preferably the edible mixture 51, extend from a first edge of the first non-edible material 31 (i.e., the right-side edge of the first non-edible material 31 in the Figure) along the center line (C/L) toward an opposite second edge (i.e., toward the left in the Figure). However, the edible layer 41 and edible mixture 51 stops short of opposite second (left-side) edge of the first non-edible material 31, leaving an extended region 33 of the first non-edible material free of edible layer 41 and edible mixture 51. When assembled, this extended region 33 will serve as a grasping region for the first non-edible material 31 to be removed by hand.

The first non-edible material 31 has properties for preventing vapor from passing therethrough. Possible materials for the first non-edible material 31 may include, but are not limited to, plastic food wrap, parchment paper, wax paper, or cellophane. As shown in the Figures, a transparent material (e.g., plastic food wrap, cellophane, etc.) is shown.

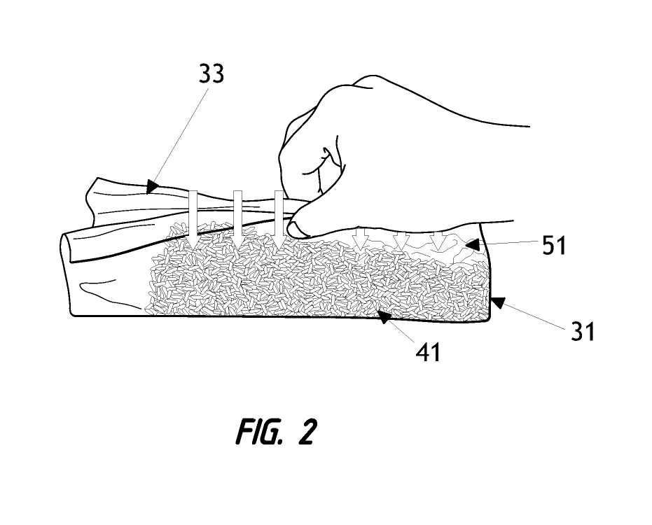

After the edible layer 41 and edible mixture 51 have been laid on the first non-edible material 31, the top and bottom edges of the first non-edible material 31 are grasped, lifted, and brought together as in FIG. 2 so that the edible layer 41 at the top end and the edible layer 41 at the bottom end come together and enclose the edible mixture 51.

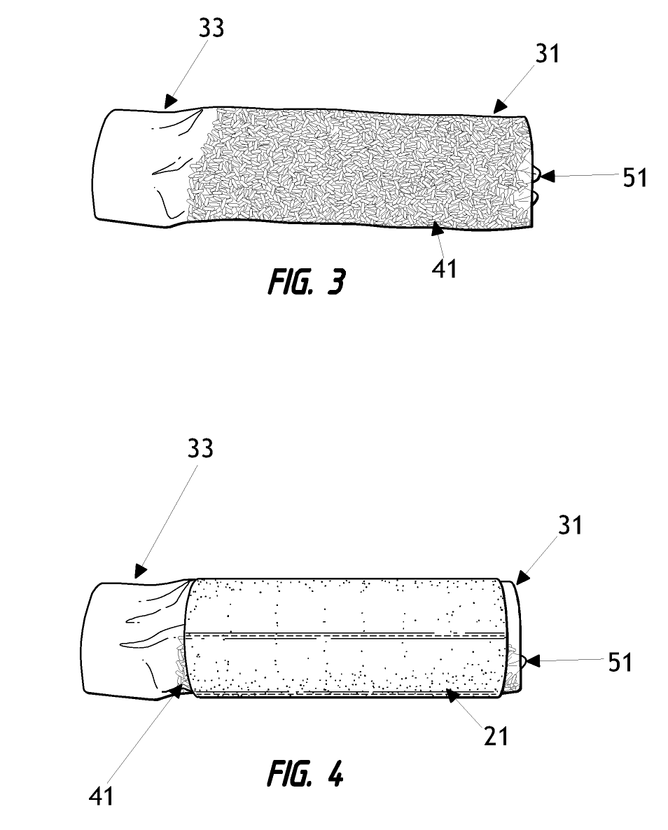

While the top and bottom edges of the first non-edible material 31 are held together, the edible layer 41 is “packed” by applying pressing motions downward and together through the first non-edible material 31 along the part of the top and bottom edges of the first non-edible material 31 held together. Once it is clear that the edible layer 41 is evenly packed around the edible mixture 51 enclosed within, one of the top or bottom edges of the first non-edible material 31 is placed beneath the other so that the first non-edible material 31 tightly wraps around the edible layer 41 as a roll to form a first rolled sub-assembly as shown in FIG. 3.

In the next step, an edible sheet material 21 is rolled around the longitudinal length of the first non-edible material 31 of the first rolled sub-assembly that surrounds the edible layer 41 and edible mixture 51 such that a remaining length of the first non-edible material 31 corresponding to the extended region 33 remains uncovered, to produce a second sub-assembly as in FIG. 4. As shown in the Figure, the longitudinal length of the edible sheet 21 material equals or is near equal to the longitudinal length of the first non-edible material 31 so that the first non-edible material 31 does not extend past the edible sheet 21 in the direction opposite the extended region 33.

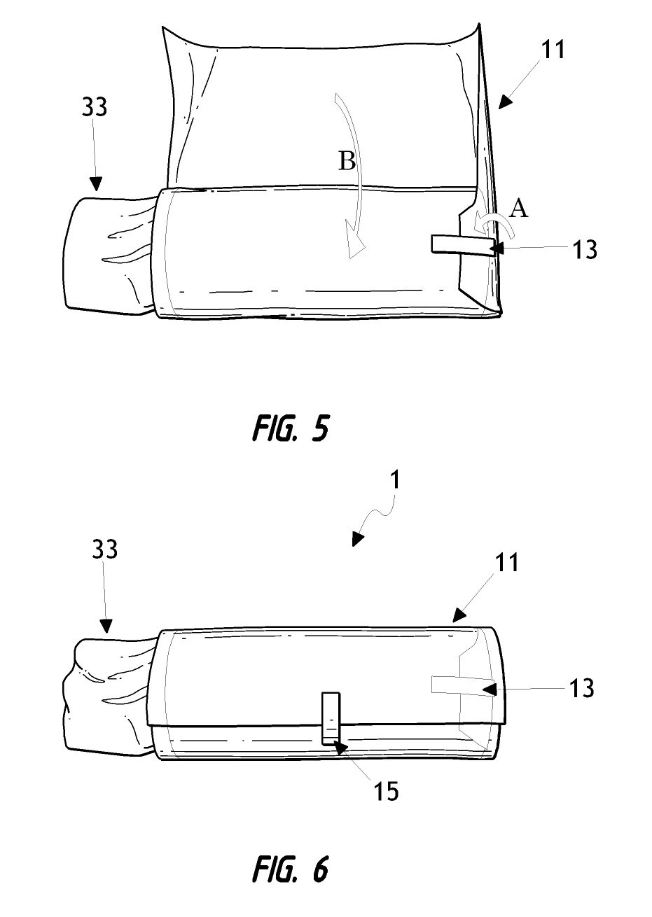

Next, a second sheet-like non-edible layer 11 is wrapped around the longitudinal length of the second rolled assembly of FIG. 4 to produce a third sub-assembly as in FIG. 5. In FIG. 5, the extended region 33 is shown as exposed from the left-side end of the third sub-assembly in order to more clearly illustrate these features. However, the second non-edible layer 11 may alternatively have a width sufficient to cover over the extended region 33 when wrapped around the second rolled assembly of FIG. 4, so long as the extended region 33 is distinguishable from the second non-edible layer 11 and is reachable by the fingers through the open end at the left for grasping.

Possible materials for the second non-edible material 11 may include, but are not limited to, plastic food wrap, parchment paper, wax paper, cellophane, or paper wrap. The sheet-like material of the second non-edible layer 11 may be the same as that of the first non-edible material 31, but this is not required. As shown in the Figures, a transparent material (e.g., plastic food wrap, cellophane, etc.) is used.

The purpose of this material for the second non-edible material 11 is similar to that of the first non-edible material 31, however, in that it is intended to keep the edible sheet material 21 fresh and crisp. As the second non-edible material 11, is intended to be the outermost layer of the packaged food product, the purpose is to prevent moisture from the surrounding air from permeating the edible sheet material 21. In addition, however, the second non-edible material 11 is also intended to be a handle for holding the packaged food product. Accordingly, the material chosen should be grippable and subject to melting or sticking to the hand (as a result, for example, of the heat and moisture inherent to the hand) while at the same time functioning as a vapor barrier between the hand and the second non-edible material 11.

In FIG. 5, the second sub-assembly of FIG. 4 is partially wrapped in the second non-edible layer 11 so that the second sub-assembly is completely wrapped at least once, while a remainder portion of the second non-edible layer 11 remains (in FIG. 5, this remainder portion is shown above the partially wrapped second sub-assembly).

Preferably, at this point, a portion of the second non-edible layer 11 extending opposite the extended region 33 is folded over in a direction of the extended region 33 as shown by the arrow “A”, and, even more preferably, secured in place as shown with an adhesive 13 such as a non-toxic tape (other means of securing may also be used as known in the art, such as a non-toxic adhesive (e.g., gum) between opposite surfaces of the non-edible layer 11 and folded portion of same). However, in folding this portion of the second non-edible layer, care should be taken not to include in the fold some portion of the first non-edible material 31 such that the sheet-like first non-edible material 31 is pinched or captured within the fold.

Once secured as above, the remainder portion is folded over in the direction of the arrow “B” over the second sub-assembly and secured in place as in FIG. 6 to produce an assembled packaged food product 1 in accordance with an embodiment of the invention. The remainder portion may, for example, be secured with an adhesive 15 such as a non-toxic tape as shown in FIG. 6 (or by other means of securing such as a non-toxic adhesive).

The steps above may be performed by hand, but may also be partially or completely performed by one or more machines.

In the exemplary embodiment described above and shown in the Figures, the edible sheet material 21 is seaweed (also known as nori). However, other suitable edible sheet materials include soy sheet, leafy green vegetables such as romaine, butter lettuce, lettuce, collard greens, kale, or other foods that can be formed into a thin, rollable sheet.

The first non-edible material 31 is a vapor barrier to prevent moisture of the edible layer 41 and edible mixture 51 from permeating into the edible sheet material 21 while the packaged food product 1 is stored, prior to being eaten.

As a result, the edible sheet material 21 is kept fresh and crisp, and therefore presents a better experience for the consumer. For example, seaweed or nori tastes better when it is dry or crisp, but tends to lose these qualities when in contact with a moist substance such as rice. By providing the first non-edible material 31 between a rice layer and a seaweed layer, the crispness of the seaweed is preserved in spite of the proximity of the rice.

However, as the first non-edible material 31 is not edible, this layer is removed prior to consuming the food product 1. To achieve this, the first non-edible material 31 is selected not just for its vapor-blocking qualities, but also for being slideable with respect to the edible layer 41 and the edible sheet material 21 so that the first non-edible material 31 is removable from the assembled food product 1.

An example of how the first non-edible material 31 is removed is shown in FIG. 7. In this example, the assembled food product 1 of FIG. 6 is held fixed, such as by being grasped along its longitudinal length by one hand (not shown) of a consumer or user intending to consume the food product 1. At the same time, the extended region 33 of the first non-edible material 31 is grasped, such as by the other hand of the user (shown at the left of FIG. 6).

As shown in FIG. 7, the hand grasping the extended region 33 makes a plurality of short pulling motions as shown by the arrow “C” so as to pull the extended region 33 in a direction of the arrow “D”. The short pulling motions help to disconnect the first non-edible layer 31 from the edible layer and from the edible sheet material 21 so that the first non-edible layer 31 slides, length by length, out from the assembled food product 1 without carrying any edible elements with it.

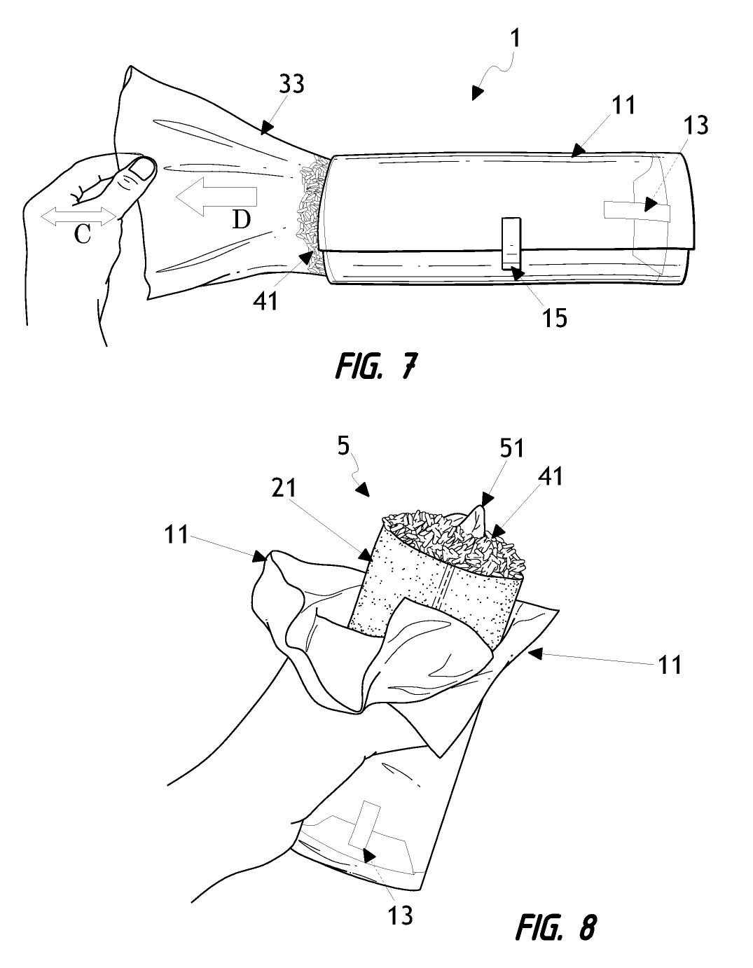

This results in an edible assembly 5 shown in FIG. 8, wherein everything contained within the second non-edible material 11 is edible. At this point, the user simply unwraps the second non-edible material to expose and consume the edible assembly 5 within. Due to the first non-edible layer that is maintained within the assembled food product 1 until such time as the user intends to eat the product, the edible sheet material 21 retains its freshness, thereby providing a more satisfying experience for the user than would otherwise be possible.

In a non-limiting variant of the invention, cooking oil, non-stick spray, or the like may be mixed in the edible layer or applied to the side of the first non-edible layer 31 that comes into contact with the edible layer 41, to enhance the slideability between the first non-edible layer 31 from the edible layer 41.

In another non-limiting variant of the invention, the second non-edible material 11 is sealed at both ends of the roll in order to further preserve freshness of the edible ingredients inside. For example, in an exemplary embodiment not shown, the second non-edible material 11 extends past the edible elements 21, 41, 51 on the end at the left of FIG. 6, and also past a length of the extended region 33 of the first non-edible material 31. This extended end of the first non-edible material 11 is then folded over itself and secured to close this end of the roll.

Alternatively, in an embodiment where the second non-edible material 11 is heat sealable, the second non-edible material 11 is heat sealed to itself at the end having the extended region 33. In this embodiment, second non-edible material 11 at the end opposite to the extended region 33 may also be sealed. In addition or alternatively, where the first non-edible material 31 is heat sealable, the non-edible material 31 at the extended region 33 may be heat sealed.

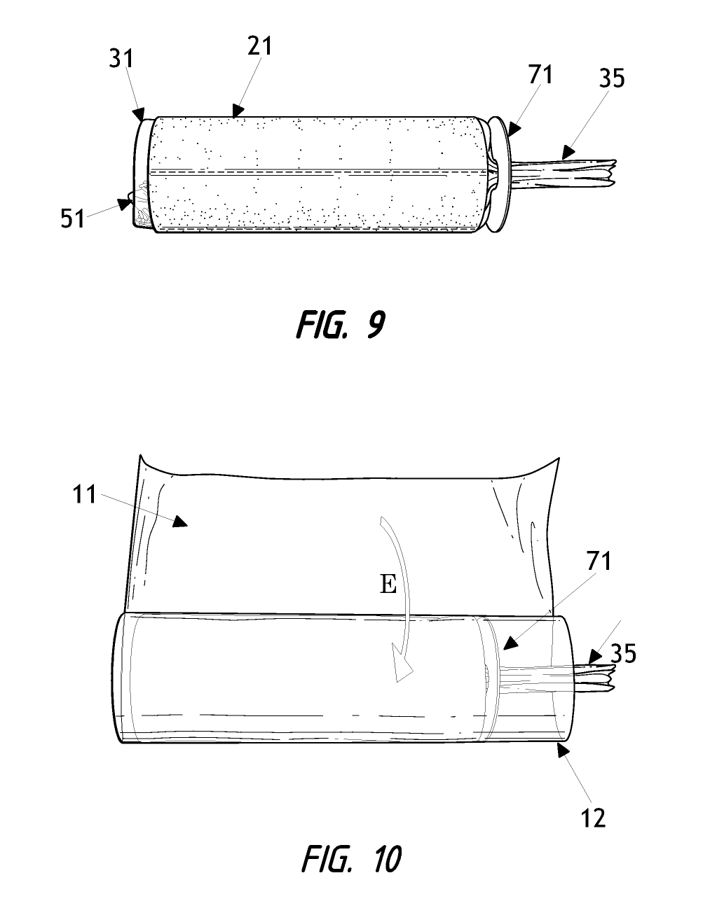

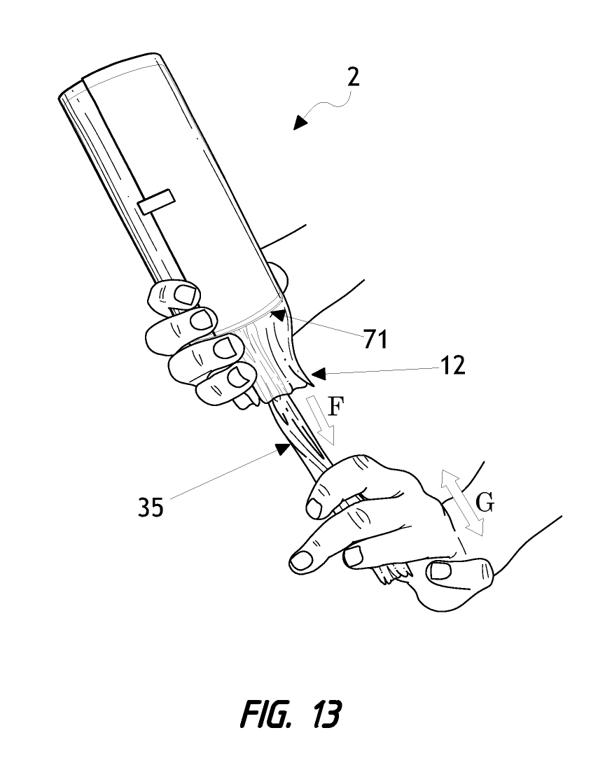

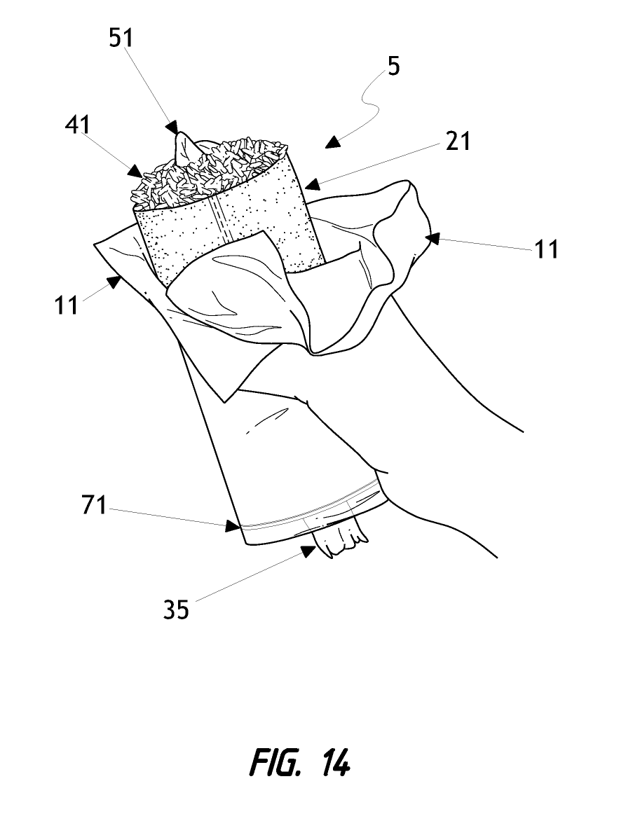

In the embodiment shown in FIG. 7, the first non-edible layer 31 is completely removed from what becomes the top of the edible assembly 5 as shown in FIG. 8. However, in another non-limiting embodiment of the invention as shown in FIGS. 9-15, the first non-edible material 31 is removable from what becomes the bottom of the edible assembly (see, e.g., FIGS. 13-15) so that the consumer may choose to only partly remove the first non-edible material 31.

In accordance with this embodiment, FIG. 9 shows a second sub-assembly similar to that shown in FIG. 4, except that a holding element 71 is provided at the end on the right of the Figure. The holding element 71 includes a hole passing through the thickness of the holding element 71, and a bottom extended region 35 of the first non-edible material 31 is inserted therethrough.

The bottom extended region 35 corresponds to the extended region 33 of FIGS. 1-3, except that the bottom extended region 35 is located on the right in FIGS. 9-13 to more clearly distinguish this embodiment from the embodiment shown in FIG. 4. In addition, the bottom extended region 35 in FIGS. 9-13 is shown as being twisted about itself to be more easily inserted through the hole of the holding element 71.

In FIG. 10, the sub-assembly shown in FIG. 9 is wrapped around its longitudinal length in the second non-edible layer 11. In this embodiment, however, the second non-edible layer 11 has an extending region 12 sufficient to surround the holding element 71 and at least partially surround the extended region 35. Also, unlike the embodiment shown in FIG. 5, FIG. 10 shows no step of folding a portion of the second non-edible layer 11 being folded over and secured in place. The second non-edible layer 11 is instead merely rolled as shown by the arrow “E” and secured in place as in FIG. 11 with an adhesive 15.

FIG. 11 thus shows an example of an assembled food product 2 in accordance with this embodiment. In the example shown, both the extended portion 35 and the extending region 12 are fastened with a clip 73.

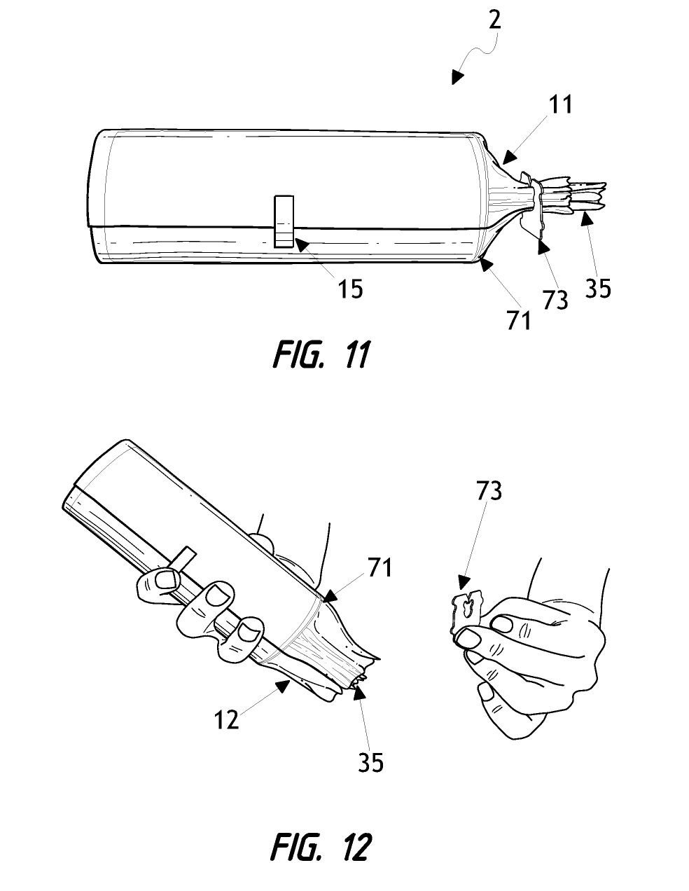

An example of how the first non-edible material 31 is removed in accordance with the embodiment shown in FIG. 11 is shown in FIG. 12. In this example, the clip 73 of the assembled food product 2 of FIG. 11 is removed from the extended portion 35 and the extending region 12. Then, as shown in FIG. 13, the assembled food product 2 is grasped in one hand at a location of the holding element 71 so that the holding element 71 is held in place and, at the same time, the extended region 35 is pulled in a direction of the arrow “F” away from the holding element 71. Preferably, the extended region 35 is pulled by way of a plurality of short pulling motions as shown by the arrow “G” in order to help disconnect the first non-edible layer 31 from the edible layer 41 and the edible sheet material 21. In pulling the extended region 35 in the direction of arrow “F”, the first non-edible material 31 slides down the longitudinal length of the assembled food product 2 in a direction corresponding to arrow “F” to incrementally expose the edible assembly 5.

The second non-edible material 11 may then be peeled back as shown in FIG. 13, and the edible assembly 5 may be consumed. If the first non-edible material 31 is not entirety removed through the hole of the holding element 71, a portion of the assembled food product 2 wherein the first non-edible material 31 has not been removed will remain in a state where the edible sheet material 21 is separated from the edible layer 41 and edible mixture 51. Thus, in this embodiment, a portion of the edible assembly 5 may be consumed while maintaining freshness of another portion.

The holding element 71 shown in FIGS. 9-14 is a disc-like element with a hole provided in its center. However, other shapes and forms may be used without exceeding the scope of the invention, as long as the holding element 71 has a stiffness sufficient to hold the edible contents of the second, fourth, and fifth layers (21, 41, 51) in place while the third first non-edible material 31 is pulled through the hole of the holding element 71.

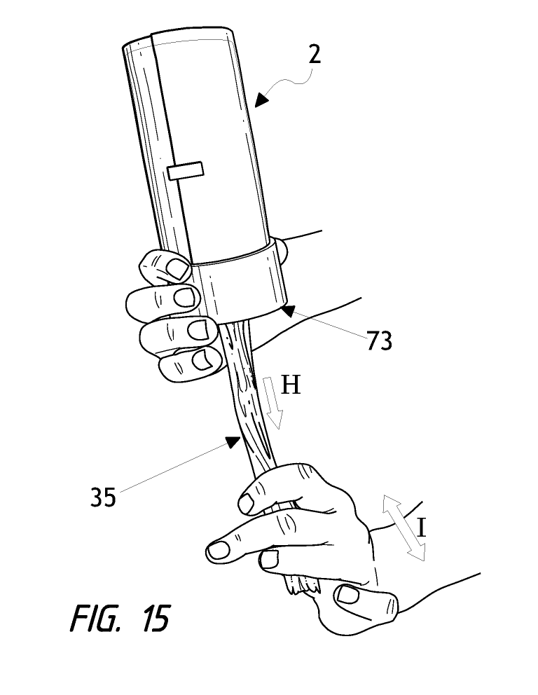

In FIG. 15, a non-limiting variation of the embodiment shown in FIG. 13 is shown where the disc-like holding element 71 is substituted with a cup-like element 73. As in the embodiment shown in FIG. 13, the bottom of the cup-like element 73 is formed of a disc-like element having a hole therethrough. Also as in the embodiment of FIG. 13, the extended region 35 is placed through the hole.

However, in the variation shown in FIG. 15, the cup-like element 73 is provided at a step following the wrapping and securing of the second non-edible layer 11, and not provided inside the second non-edible layer 11 as the holding element 71 is shown in FIGS. 9-14.

In FIG. 15, the side walls of the cup-like element 73 are provided over an exterior of the second non-edible layer. For removing the first non-edible material 31 in FIG. 15, the outer surface of the cup-like element 73 provides a gripping area for holding the assembled food product 2 while the extended region 35 is pulled in the direction of arrow “H” in response to short pulling motions shown by the arrow “I”. As in the embodiment of FIG. 13, pulling the extended region 35 in the direction of arrow “H” causes the first non-edible material 31 to slide down the longitudinal length of the assembled food product 2 in a direction corresponding to arrow “H” to incrementally expose the edible assembly 5, thereby making a portion of the edible assembly 5 consumable while maintaining freshness of another portion.

In the preceding description, for purposes of explanation, numerous details are set forth in order to provide a thorough understanding of the embodiments of the present invention. However, it will be apparent to one skilled in the art that these specific details are not required in order to practice the present invention. The invention as described herein may comprise one, several, all, or any of the embodiments provided above in any combination.

The above-described embodiments of the present invention are intended to be examples only. Alterations, modifications and variations can be effected to the particular embodiments by those of skill in the art without departing from the scope of the invention, which is defined solely by the claims appended hereto.

What is claimed is:

1. A method for making a packaged food product (1), comprising the steps of:
providing a first non-edible layer of sheet-like material (31) on a preparation surface, the first non-edible layer (31) having a first edge, a second edge opposite said first edge, and two opposite side edges;
spreading a thin layer of an edible substrate (41) onto the first flexible non-edible material (31) between the first edge of the first non-edible layer (31) and the second edge of the first non-edible layer (31), an extended region (33) of the first non-edible layer at the second edge remaining free of the edible substrate (41);
placing a layer of one or more edible ingredients (51) on the edible substrate (41) along a center line of the edible substrate (41);
lifting the two opposite side edges of the first non-edible layer (31) from the preparation surface, and bringing the two opposite side edges together to enclose the edible substrate (41) around the layer of one or more edible ingredients (51);
placing a first of the two opposite side edges over a second of the two opposite side edges to close the first non-edible layer (31) around the edible substrate (41) and the layer of one or more edible ingredients (51), such that the first non-edible layer (31), the edible substrate (41), and the layer of one or more edible ingredients (51) form a rolled sub-assembly;
rolling the rolled sub-assembly inside an edible sheet-like material (21) to form a second rolled sub-assembly;
rolling the second rolled sub-assembly into a second non-edible layer of sheet-like material (11); and
securing the second non-edible layer (11) to prevent the second non-edible layer (11) from unrolling,
wherein the first non-edible layer (31) is a vapor barrier that prevents transmission of moisture from the edible substrate (41) to the edible sheet-like material (21),
wherein the first non-edible layer (31) is slideable from between the edible sheet-like material (21) and the edible substrate (41) such that the first non-edible layer (31) may be pulled, by grasping the extended region (33), and removed from between the edible sheet-like material (21) and the edible substrate (41).

2. The method of claim 1, wherein the edible sheet-like material (21) is seaweed.

3. The method of claim 1, wherein the edible substrate (41) comprises one of rice, egg, leafy green vegetable, or grain and bean mixture.

4. The method of claim 1, wherein the edible sheet-like material (21) is a soy sheet.

5. The method of claim 1, wherein the first non-edible layer (31) consists of clear plastic food wrapping material or cellophane.

6. The method of claim 1, wherein the first non-edible layer (31) consists of clear plastic food wrapping material or cellophane, and the second non-edible layer (11) consists of food wrapping paper.

7. The method of claim 1, further comprising:
mixing oil into the edible substrate (41) to facilitate sliding between the first non-edible layer (31) and the edible substrate (41).

8. The method of claim 1, further comprising:
treating the first non-edible layer (31) with non-stick spray on a side that contacts the edible substrate (41) to facilitate sliding between the first non-edible layer (31) and the edible substrate (41).

9. The method of claim 1, further comprising:
sealing the second non-edible layer (11) at an open end of the rolled final assembly to prevent exposure of the edible substrate (41), edible ingredients (51), and edible sheet-like material (21) to the outside.

10. The method of claim 9, wherein the second non-edible layer (11) comprises a heat sealable food wrapping material, and wherein the second non-edible layer (11) is sealed by heat-sealing.

11. The method of claim 1, wherein the step of rolling the second rolled sub-assembly into a second non-edible layer of sheet-like material (11) comprises the sub-steps of:
partly rolling the second rolled sub-assembly into the second non-edible layer of sheet-like material (11);
folding up a bottom end of the partly rolled second non-edible layer (11) against an exposed surface of the second non-edible layer (11); and
securing an end-most portion of the folded bottom end to the exposed surface of the second non-edible layer (11).

12. The method of claim 1, further comprising:
after the step of rolling the second rolled sub-assembly around the remainder portion of the second non-edible layer (11) to form the rolled final assembly, providing a cup element (73), having a hole extending through a bottom thereof, at an end of the rolled final assembly such that an inner surface of the bottom of the cup element (73) faces the end of the rolled final assembly, and the extended region (35) of the first non-edible layer is placed through the hole of the cup element (73) thereby to extend from an outer surface of the bottom of the cup element (73).

13. The method of claim 1, further comprising:
after the step of placing the first of the two opposite side edges over the second of the two opposite side edges to close the first non-edible layer and form the rolled sub-assembly, providing a holding element (71), having a hole extending therethrough, at an end of the rolled sub-assembly such that a first surface of the holding element (71) faces the end of the rolled sub-assembly, and the extended region (35) of the first non-edible layer is placed through the hole of the holding element (71) thereby to extend from an opposite second surface of the holding element (71).

14. The method of claim 13, further comprising:
fitting one of a clip or a tie around the extended region (35) of the third layer (31) to seal the extended region (35) of the third layer (31)
